(19) United States
(12) Patent Application Publication
(10) Pub. No.: US 2015/0370371 A1
(43) Pub. Date: Dec. 24, 2015

(54) DISPLAY DEVICE HAVING TOUCH DETECTION FUNCTION

(71) Applicant: Japan Display Inc., Tokyo (JP)

(72) Inventors: Kohei AZUMI, Tokyo (JP); Yoshitoshi KIDA, Tokyo (JP); Shinya IUCHI, Tokyo (JP)

(21) Appl. No.: 14/743,032

(22) Filed: Jun. 18, 2015

(30) Foreign Application Priority Data
Jun. 18, 2014 (JP) 2014-125418

(51) Int. Cl. G06F 3/044

(52) U.S. Cl. CPC G06F 3/044

(57) ABSTRACT

A display device is provided and having a touch detection function includes drive electrodes, detection electrodes, a display driver which performs a touch scanning drive and a display scanning drive, and a touch driver which obtains touch information including detection information on the closely situated external object by acquiring detection signals from the detection electrodes. The display driver acquires the image signal, which is input in response to a master synchronizing signal output to the outside, and outputs the touch synchronizing signal to the touch driver after a predetermined time elapses from time when the image signal is input. The touch driver starts to operate in response to the touch synchronizing signal from the display driver, to acquire the touch information, and outputs the touch information to the outside to cause production of the image signal to start.

### CROSS REFERENCES TO RELATED APPLICATIONS

The present application claims priority to Japanese Priority Patent Application JP 2014-125418 filed in the Japan Patent Office on Jun. 18, 2014, the entire content of which is hereby incorporated by reference.

### FIELD

Embodiments described herein relate generally to a driving device, a display device having a touch detection function and an information processing device.

### BACKGROUND

In recent years, attention has been given to display devices in which a touch detection device referred to as a so-called touch panel is provided on a display device such as a liquid crystal display device, or a touch panel and a display device are integrated as a single body, and the display device is made to display various button images to enable information to be input without ordinary real buttons. Such display devices having a touch detection function do not need input devices such as a keyboard, a mouse and a keypad, and thus tend to be broadly used as display devices of computers, portable information terminals such as cell phones, etc.

As such a touch panel, a capacitive touch panel is known in which a plurality of electrodes each formed to extend in a single direction are intersected to each other. In this touch panel, the electrodes are connected to a control circuit, and when supplied with an excitation current from the control circuit, they detect an object close thereto.

As a display device having touch detection function, a so-called in-cell touch panel is proposed in addition to a so-called on-cell touch panel in which a touch panel is provided on a display surface of a display device. In the in-cell display device, a common electrode for display, which is originally provided in the display device, is also used as one of a pair of electrodes for a touch sensor, and the other of the pair of electrodes (a touch detection electrode) is provided to intersect the common electrode.

A display device having a touch detection function is disclosed (in Jpn. Pat. Appln. KOKAI Publication No. 2012-68980) in which drive electrodes for touch sensor are sequentially selected in a time sharing manner such that a predetermined number of drive electrodes for touch sensor are selected at a time; a touch detection drive signal is supplied to selected drive electrodes; and a scanning drive is performed at a scanning pitch which is smaller than the total width of the selected drive electrodes (this scanning drive will be hereinafter referred to as “bundle drive”).

It should be noted that since the above bundle drive also needs to synchronize with a display operation, the above display device having the touch detection function is configured to execute a touch drive control and a display control such that a touch driver (TPIC) which primarily controls a touch drive operation and a display driver (DDI) which controls the display operation operate in cooperation with each other. Also, the touch driver TPIC and the display driver DDI operate with an external processor HOST, and as a result, the touch driver TPIC and the display driver DDI cooperate with the external processor HOST and those three modules form an information processing device.

It should be noted that the touch driver TPIC, the display driver DDI and the processor HOST are configured to operate in synchronism with clocks generated by standard frequency generators provided in the touch driver TPIC, the display driver DDI and the processor HOST, respectively. That is, the operations of the touch driver TPIC, the display driver DDI and the processor HOST are essentially asynchronous to each other. Inevitably, the touch drive operation and the display operation are not smoothly performed in concert with each other.

### SUMMARY

In general, according to one embodiment, a display device having touch detection function includes a plurality of drive electrodes arranged side by side to extend in a first direction; a plurality of detection electrodes extending in a second direction crossing the first direction, and provided to generate capacitances at intersections of the detection electrodes and the drive electrodes; a display driver which performs a touch scanning drive in which the drive electrodes are successively supplied with a touch drive signal for detecting a closely situated external object, and a display scanning drive in which display elements are successively supplied with display signals to be displayed by the display elements, after producing the display signals from an image signal input from the outside; and a touch driver which obtains touch information including detection information on the closely situated external object by acquiring detection signals from the detection electrodes, wherein the display driver acquires the image signal, which is input in response to a master synchronizing signal output to the outside, and outputs the touch synchronizing signal to the touch driver after a predetermined time elapses from time when the image signal is input, and the touch driver starts to operate in response to the touch synchronizing signal from the display driver, to acquire the touch information, and outputs the touch information to the outside to cause production of the image signal to start.

In general, according to another embodiment, a display device having touch detection function, includes a plurality of drive electrodes arranged side by side to extend in a first direction; a plurality of detection electrodes extending in a second direction crossing the first direction, and provided to generate capacitances at intersections of the detection electrodes and the drive electrodes; a display driver which performs a touch scanning drive in which the drive electrodes are successively supplied with a touch drive signal for detecting a closely situated external object, and a display scanning drive in which display elements are successively supplied with display signals to be displayed by the display elements, after producing the display signals from an image signal input from the outside; and a touch driver which obtains touch information including detection information on the closely situated external object by acquiring detection signals from the detection electrodes, wherein the display driver produces display signals from the image signal upon reception of a display synchronizing signal input from the outside to the display driver, and then outputs the display signals to display elements; and outputs a touch synchronizing signal to the touch driver after a predetermine time elapses from time at which the display synchronizing signal is input, and the touch driver starts to operate in response to the touch synchronizing signal from the display driver, to acquire the touch information, and outputs the touch information to the outside to cause production of the image signal to start.

Additional features and advantages are described herein, and will be apparent from the following Detailed Description and the figures.

### BRIEF DESCRIPTION OF THE FIGURES

A general architecture that implements the various features of the embodiments will now be described with reference to the drawings. The drawings and the associated descriptions are provided to illustrate the embodiments and not to limit the scope of the invention.

FIG. 1 is an exemplary view schematically showing a structure of a display device of a display device having a touch detection function, according to a first embodiment;

FIG. 2 is an exemplary cross-sectional view showing in more detail the structure of the display device having the touch detection function according to the first embodiment;

FIG. 3 is an exemplary view showing a representative basic structure with respect to a mutual detection method of the display device having the touch detection function according to the first embodiment;

FIG. 4A is an exemplary view schematically showing a structure of a sensor in the display device having the touch detection function according to the first embodiment;

FIG. 4B is another exemplary view schematically showing the structure of the sensor in the display device having the touch detection function according to the first embodiment;

FIG. 5A is an exemplary view for explaining a drive method of the mutual detection method of the display device having the touch detection function according to the first embodiment;

FIG. 5B is another exemplary view for explaining the drive method of the mutual detection method of the display device having the touch detection function according to the first embodiment;

FIG. 6 is an exemplary view for explaining connections of drive source lines in the display device having the touch detection function according to the first embodiment;

FIG. 7 is an exemplary view showing main signals to be transmitted and received between a processor and the display device having the touch detection function according to the first embodiment;

FIG. 8 is an exemplary time chart showing a flow of transmission and reception of main signals between the processor and the display device having the touch detection function according to the first embodiment;

FIG. 9 is an exemplary view showing transmission and reception of main signals between a processor and a display device having a touch detection function, according to a second embodiment;

FIG. 10 is an exemplary time chart showing a flow of transmission and reception of main signals between a processor and the display device having the touch detection function according to the second embodiment;

FIG. 11A is an exemplary view for explaining an advantage of a synchronous drive between the processor and the display device having the touch detection function according to each of the first and second embodiments; and

FIG. 11B is another exemplary view for explaining the advantage of the synchronous drive between the processor and the display device having the touch detection function according to each of the first and second embodiments.

### DETAILED DESCRIPTION

Various embodiments will be described hereinafter with reference to the accompanying drawings.

In general, according to one embodiment, a display device having touch detection function, including:

a plurality of drive electrodes arranged side by side to extend in a first direction;

a plurality of detection electrodes extending in a second direction crossing the first direction, and provided to generate capacitances at intersections of the detection electrodes and the drive electrodes;

a display driver which performs
a touch scanning drive in which the drive electrodes are successively supplied with a touch drive signal for detecting a closely situated external object, and
a display scanning drive in which display elements are successively supplied with display signals to be displayed by the display elements, after producing the display signals from an image signal input from the outside; and

a touch driver which obtains touch information including detection information on the closely situated external object by acquiring detection signals from the detection electrodes,

wherein

the display driver acquires the image signal, which is input in response to a master synchronizing signal output to the outside, and outputs the touch synchronizing signal to the touch driver after a predetermined time elapses from time when the image signal is input, and

the touch driver starts to operate in response to

the touch synchronizing signal from the display driver, to acquire the touch information, and outputs the touch information to the outside to cause production of the image signal to start.

Various embodiments will be described hereinafter with reference to the accompanying drawings.

It should be noted that they are described as examples, and needless to say, if they are modified as appropriate without departing from the subject matter of the present invention, and easily conceived by a person with ordinary skill in the art, such a modification or modifications fall within the scope of the present invention. Furthermore, some part of the drawings schematically show elements in width, thickness, shape, etc., as compared with actual ones. They show them by way of example, and do not limit an interpretation of the present invention. In addition, in the specification and the drawings, elements identical to those explained previously will be denoted by the same reference numerals as the previously explained elements, and after they are each explained once, detailed explanations of some of the elements will be omitted as appropriate.

### First Embodiment

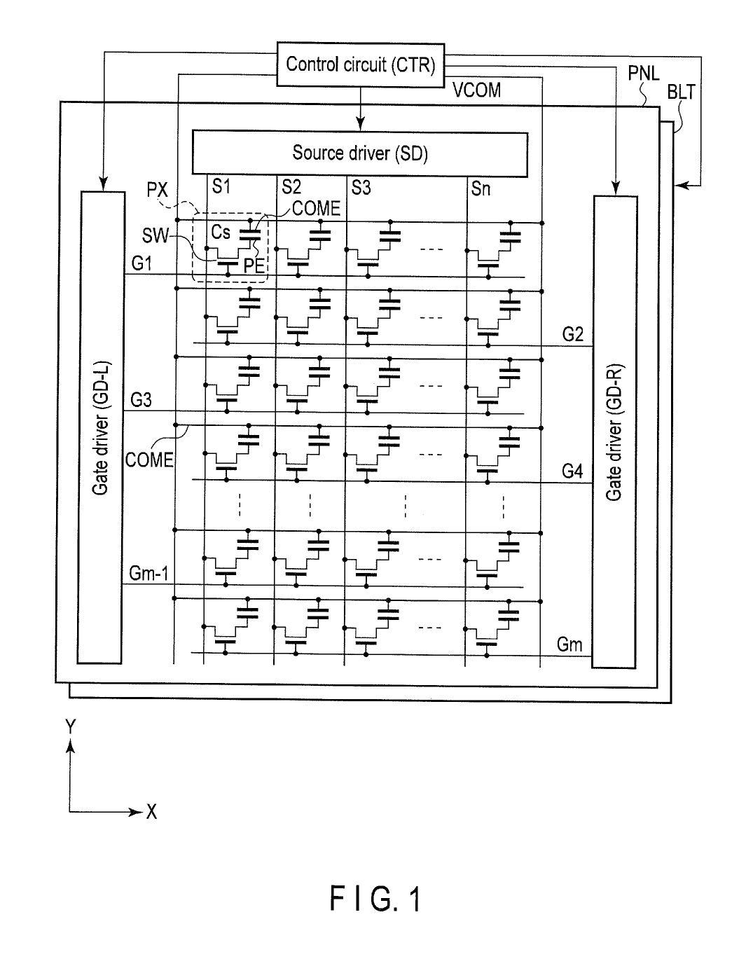

FIG. 1 is an exemplary view schematically showing a structure of a display device of a display device DSP having a touch detection function, according to the first embodiment. It should be noted that in the first embodiment, the display device is a liquid crystal display device; and “touch detection” is a term which means not only that it is detected that a finger or the like contacts a touch panel, but that it is detected that the finger or the like is located close to the touch panel.

The display device comprises a display panel PNL and a backlight BLT which illuminates the display panel PNL from a rear surface side thereof. The display panel PNL comprises a display portion including display pixels PX arranged in a matrix.

As shown in FIG. 1, the display portion comprises gate lines G (G1, G2, . . . ), source lines S (S1, S2, . . . ) and pixel switches SW, the gate lines G extending along display pixels PX arranged in a row direction, the source lines S extending along display pixels PX arranged in a column direction, the pixel switches SW arranged close to intersections of the gate lines G and the source lines S.

The pixel switches SW comprise thin film transistors (TFTs). Gate electrodes of the pixel switches SW are electrically connected to associated gate lines G. Source electrodes of the pixel switches SW are electrically connected to associated source lines S. Drain electrodes of the pixel switches SW are electrically connected to associated pixel electrodes PE.

Furthermore, as drive means for driving the display pixels PX, gate drivers GD (left GD-L and right GD-R) and a source driver SD are provided. The gate lines G are electrically connected to output terminals of the gate drivers GD. The source lines S are electrically connected to output terminals of the source driver SD.

The gate drivers GD and the source driver SD are located in a peripheral area (frame edge) of the display area. The gate drivers GD successively applies on-voltages to the gate lines G, as a result of which the on-voltages are applied to the gate electrodes of pixel switches SW, which are electrically connected to selected gate lines G. To be more specific, when an on-voltage is applied to a gate electrode, electrical conduction is effected between a source electrode and a drain electrode of a pixel switch SW including the above gate electrode. On the other hand, the source driver SD supplies output signals to the source lines S, respectively. To be more specific, when an output signal is supplied to a signal line S, it is also supplied to an associated pixel electrode PE through the pixel switch SW which is being switched on.

Operations of the gate drivers GD and the source driver SD are controlled by a control circuit CTR provided outside the liquid crystal display panel PNL. Furthermore, the control circuit CTR applies a common voltage Vcom to a common electrode COME which will be described later, and also controls an operation of the backlight BLT.

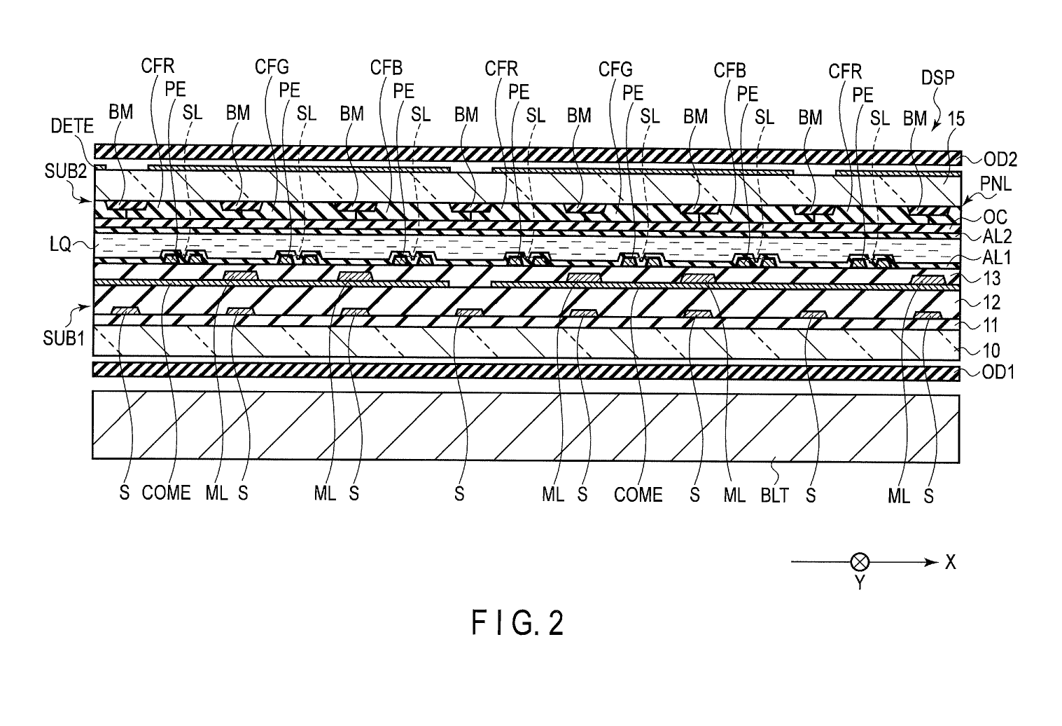

FIG. 2 is an exemplary cross-sectional view showing in more detail the structure of the display device DSP having the touch detection function, according to the first embodiment.

The display device DSP having the touch detection function comprises a display panel PNL, a backlight BLT, a first optical element OD1 and a second optical element OD2. In an example shown in FIG. 2, the display panel PNL is a liquid crystal display panel; however, as the display panel PNL, another type flat panel such as an organic electroluminescence display panel may be applied. Also, the display panel PNL as shown in FIG. 2 has a structure conforming to a fringe field switching (FFS) mode which is a display mode; however, it may have a structure conforming to another display mode.

The display panel PNL comprises a first substrate SUB 1, a second substrate SUB2 and a liquid crystal layer LQ. The first substrate SUB1 and the second substrate SUB2 are stacked together, with a predetermined cell gap interposed between them. The liquid crystal layer LQ is held in the cell gap between the first substrate SUB1 and the second substrate SUB2.

The first substrate SUB1 is formed using a first insulating substrate 10 having a light transmission characteristic, such as a glass substrate or a resin substrate. On a side of the first insulating substrate 10 which is located opposite to the second substrate SUB2, the first substrate SUB1 comprises source lines S, a common electrode COME, pixel electrodes PE, a first insulating film 11, a second insulating film 12, a third insulating film 13, a first alignment film AL1, etc.

The pixel electrodes PE and the common electrode COME form, along with a pixel area of the liquid crystal layer which is located between those electrodes, display pixels; and the display pixels are arranged in a matrix in the display panel PNL.

The first insulating film 11 is provided on the first insulating substrate 10. It should be noted that although it will not be explained in detail, between the first insulating substrate 10 and the first insulating film 11, the gate lines G, gate electrodes of switching elements, a semiconductor layer, etc., are provided. The source lines S are formed on the first insulating film 11. Also, drain electrodes and source electrodes of the switching elements, etc., are formed on the first insulating film 11. In the example shown in the figure, the source lines S extend parallel to the common electrode COME in a second direction Y.

The second insulating film 12 is provided on the source lines S and the first insulating film 11. The common electrode COME is formed on the second insulating film 12. In the example shown in the figure, the common electrode COME comprises a plurality of segments. The segments of the common electrode COME extend in the second direction Y, and spaced from each other in a first direction X. Such a common electrode COME is formed of a transparent conductive material such as indium tin oxide (ITO) or indium zinc oxide (IZO). It should be noted that in the example shown in the figure, although metal layers ML are formed on the common electrode COME to reduce the resistance of the common electrode COME, they may be omitted.

The third insulating film 13 is provided on the common electrode COME, the metal layers ML and the second insulating film 12. The pixel electrodes PE are formed above the third insulating film 13. Also, each of the pixel electrodes PE is located between associated adjacent two of the source lines S as viewed from above and opposite to the common electrode COME as viewed on-side. Furthermore, the pixel electrodes PE include slits SL located opposite to the common electrode COME. Such pixel electrodes PE are formed of transparent conductive material such as ITO or IZO. The first alignment film AL1 covers the pixel electrodes PE and the third insulating film 13.

On the other hand, the second substrate SUB2 is formed of a second insulating substrate 15 having a light transmission characteristic, such as a glass substrate or a resin substrate. On a side of the second insulating film 15 which is located opposite to the first substrate SUB1, the second substrate SUB2 comprises black matrixes BM, color filters CFR, CFG and CFB, an overcoat layer OC, a second alignment film AL2, etc.

The black matrixes BM are formed on an inner surface of the second insulating film 20, and partition pixels. Color filters CFR, CFG and CFB are also formed on the inner surface of the second insulating film 20, and partially stacked on the black matrixes BM. The color filters CFR are red filters; the color filters CFG are green filters; and the color filters CFB are blue filters. The overcoat layer OC covers the color filters CFR, CFG and CFB. Also, the overcoat layer OC is formed of transparent resin material. The second alignment film AL2 covers the overcoat layer OC.

A detection electrode DETE is formed on an outer surface of the second insulating film 15. Although the detection electrode DETE includes detection electrodes arranged in the manner of stripes, which will be described later, and it is simply shown. Also, a detailed figure of lead lines is omitted. The structure of the detection electrode DETE will be described in detail later. The detection electrode DETE is formed of transparent conducive material such as ITO or IZO.

The backlight BLT is provided on a rear surface side of the display panel PNL. As the backlight BLT, various types of backlights can be applied, and for example, a backlight employing a light emitting diode (LED) or a cold-cathode fluorescent lamp (CCFL) as a light source can be applied. A detailed explanation of the structure of the backlight BLT will be omitted.

The first optical element OD1 is provided between the first insulating substrate 10 and the backlight BLT. The second optical element OD2 is provided above or on the detection electrode DETE. Each of the first optical element OD1 and the second optical element OD2 includes at least a polarizing plate, and may include a retardation plate as occasion demands.

Next, a touch sensor applied to the display device DSP having the touch detection function according to the first embodiment will be explained. As a method of detecting that the user's finger or a pen touches the touch panel or is close to the touch panel, a principle of a self-capacitance method (also referred to as a mutual detection method) will be explained.

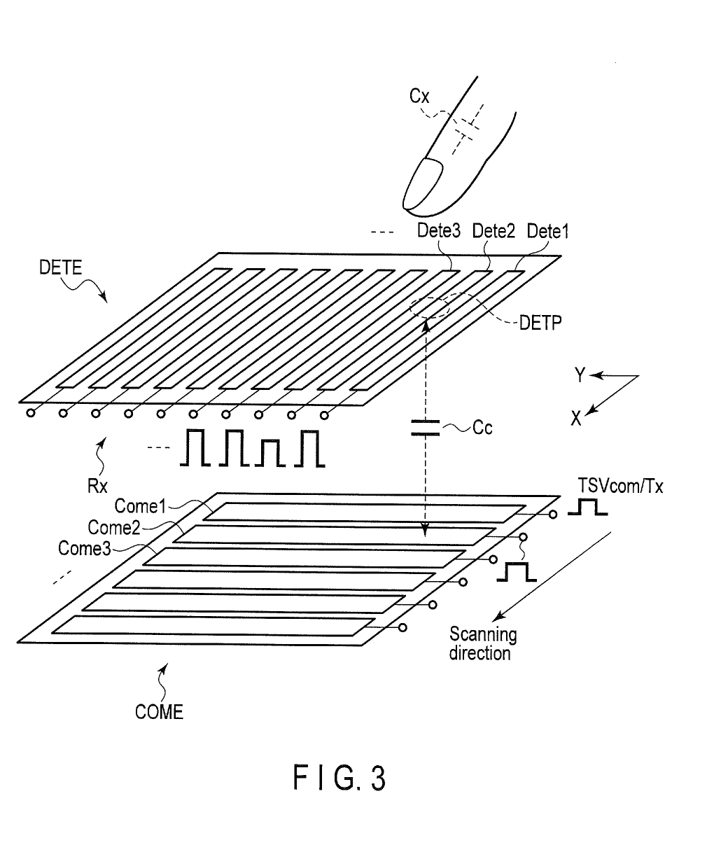

FIG. 3 is an exemplary view showing a representative basic structure of the mutual detection method of the display device DSP having the touch detection function according to the first embodiment. The common electrode COME and the detection electrode DETE are used. The common electrode COME includes a plurality of common electrodes Come1, Come2, Come3, . . . arranged in the manner of stripes. The common electrodes Come1, Come2, Come3, . . . are also arranged in the scanning (driving) direction (Y direction or X direction).

The detection electrode DETE includes a plurality of detection electrodes Dete1, Dete2, Dete3, . . . arranged in the manner of stripes. Those detection electrodes arranged in the manner of stripes may be thinner than the common electrodes arranged in the manner of stripes. The detection electrodes Dete1, Dete2, Dete3 . . . are also arranged in a direction (the X direction or the Y direction) crossing the common electrodes Come1, Come2, Come3, . . . .

The common electrodes Come1, Come2, Come3, . . . arranged in the manner of stripes in the common electrode COME and detection electrodes Dete1, Dete2, Dete3, . . . arranged in the manner of stripes in the detection electrode DETE are spaced from each other. Thus, basically, capacitors Cc are present between the common electrodes Come1, Come2, Come3, . . . and the detection electrodes Dete1, Dete2, Dete3, . . . .

The common electrodes Come1, Come2, Come3, . . . are scanned by drive pulses TSVCOM at predetermined intervals. If the user's finger is located close to the detection electrode Dete2, when the drive pulses TSVCOM are supplied to the common electrode Come2, amplitudes of the detection pulses obtained from the detection electrode Dete2, are lower in level than pulses obtained from the other detection electrodes arranged in the manner of stripes. This is because a capacitance Cx is generated by the finger, and is added to a capacitance Cc. In the mutual detection, the above obtained pulse having a lower level can be used as a detection pulse for a position DETP.

The above capacitance Cx varies in accordance with whether the finger is close to or far from a detection electrode DETE. Thus, the level of the detection pulses also varies in accordance with whether the user's finger is close to or far from the detection electrode DETE. It is therefore possible to determine from the level of the detection pulses how close the finger is to the flat surface of the touch panel. Needless to say, a two-dimensional position of the finger on the flat surface of the touch panel can be detected based on an electrode driving timing of the drive pulses TSVCOM and an output timing of the detection pulses.

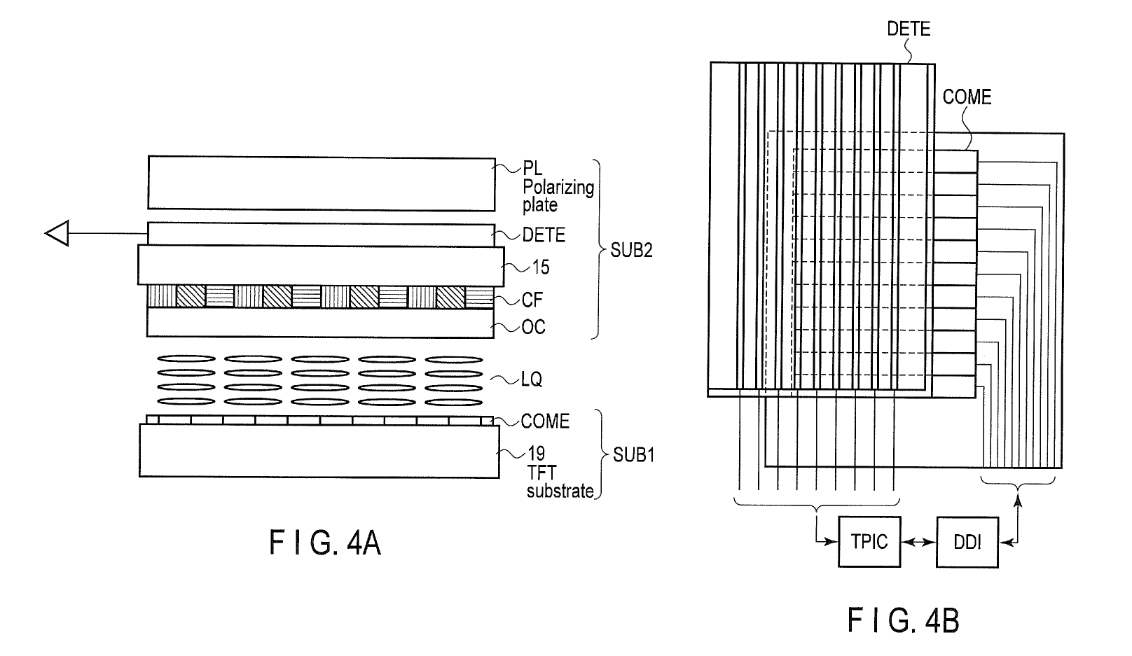

FIGS. 4A and 4B are exemplary views schematically showing the structure of the sensor in the display device DSP having the touch detection function according to the first embodiment. FIG. 4A is a cross-sectional view of the display device DSP having the touch detection function, and FIG. 4B is a plan view showing the structure of the sensor.

As shown in FIG. 4A, the display device DSP having the touch detection function comprises the first substrate SUB1, the second substrate SUB2 and the liquid crystal layer LQ held between the first substrate SUB1 and the second substrate SUB2.

The first substrate SUB1 comprises a TFT substrate 19 and the common electrode COME. The TFT substrate 19 comprises a transparent insulating substrate formed of glass or the like, switching elements not shown, various lines including source lines, gate lines, etc., and a flattening layer which is an insulating film covering those lines. The common electrode COME is provided on the TFT substrate 19 and covered by an insulating layer. The common electrodes Come1, Come2, Come3, . . . included in the common electrode COME, for example, extend in the first direction, and are arranged in the manner of stripes in the second direction crossing the first direction. The common electrodes Come 1, Come2, Come 3, . . . in the common electrode COME are formed of transparent electrode material such as ITO or IZO. In the first embodiment, The common electrodes Come 1, Come2, Come 3, . . . in the common electrode COME are also used as drive electrodes for the sensor.

The second substrate SUB2 comprises a transparent insulating substrate (second insulating substrate) 15 such as glass, the color filters CF, the detection electrode DETE and a polarizing plate PL. The color filters CF are provided on the transparent insulating substrate 15, and covered by the overcoat layer OC. The detection electrode DETE is provided on a main outer surface of the transparent insulating substrate 15 (which is located opposite to the color filters CF). The detection electrodes Dete1, Dete2, Dete3, . . . included in the detection electrode DETE extend in a direction (second direction) crossing an extending direction (first direction) of the common electrodes Come1, Come2, Come3, . . . in the common electrode COME, and are arranged in the manner of stripes in the first direction. The detection electrodes Dete1, Dete2, Dete3, . . . in the detection electrode DETE are formed of transparent electrode material such as ITO or IZO. The polarizing plate PL is provided above or on the detection electrode DETE (on a side of the transparent insulating substrate 15 which is located opposite to the color filters CF).

FIG. 4B is a view for use in explaining an example of a structure of each of the above common electrode COME and the detection electrode DETE. In the display device DSP having the touch detection function according to the first embodiment, a touch driver TPIC and a display driver DDI cooperates with each other, whereby drive pulses TSVCOM are input to the common electrode COME, and detection pulses are obtained from the detection electrode DETE. The display driver DDI outputs the drive pulses TSVCOM, and the touch driver TPIC grasps a touch position of the finger based on the position of part of the common electrode COME, to which the drive pulses TSVCOM are input, and the waveform of the detection pulses. It should be noted that it can be set that the touch position is calculated by an external device not shown. A signal output from the display driver DDI and transmission and reception of signals between the display driver DDI and the touch driver TPIC will be explained in detail later.

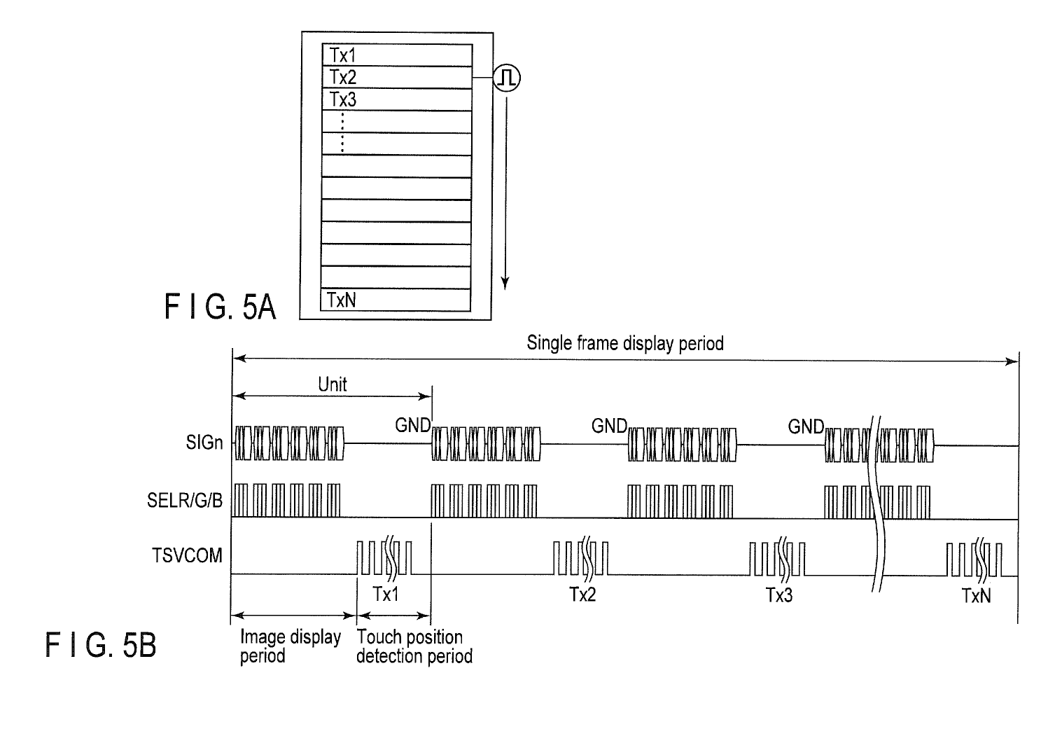

FIGS. 5A and 5B are exemplary views for explaining a drive method of the mutual detection method of the display device DSP having the touch detection function according to the first embodiment.

FIG. 5A shows drive units Tx of the common electrode COME. Drive units Tx1, . . . TxN are formed of common electrodes Come in the common electrodes COME, respectively, which are successively arranged in the manner of stripes. It should be noted that the drive units Tx1, . . . TxN may correspond to several ones of the common electrodes Come1, Come2, Come3, . . . arranged in the manner of stripes, respectively. Alternatively, the drive units Tx1, . . . TxN may correspond to the common electrodes Come1, Come2, Come3, . . . arranged in the manner of stripes, respectively. As described above, the common electrodes Come in the common electrodes COME for use in displaying an image are also used as drive electrodes for touch position detection. Thus, an image display operation and a touch position detection operation are performed in a time sharing manner.

In a driving method as shown in FIG. 5B, a single frame period comprises a plurality of units. A single unit is divided into image display periods in each of which an image is displayed and touch position detection periods in each of which a touch position is detected. In the single frame period, the image display periods and the touch position detection periods are alternately repeated. To be more specific, in response to a signal (SELR/G/B) for selecting any of three colors of RGB, an operation for outputting an image signal (SIGn) corresponding to the selected color is performed on each of a plurality of display lines, and thereafter a mutual detection operation is performed in which drive pulses TSVCOM are input to the drive units Tx (the common electrodes Come arranged in the manner of stripes). Then, the plurality of display lines and the drive units Tx (Tx1, . . . TxN) are successively subjected to the above operations. It should be noted that the display operation and touch drive operation may be controlled in synchronism with each other such that the display lines and lines of the drive units Tx are made to conform to each other, or may be controlled independent of each other.

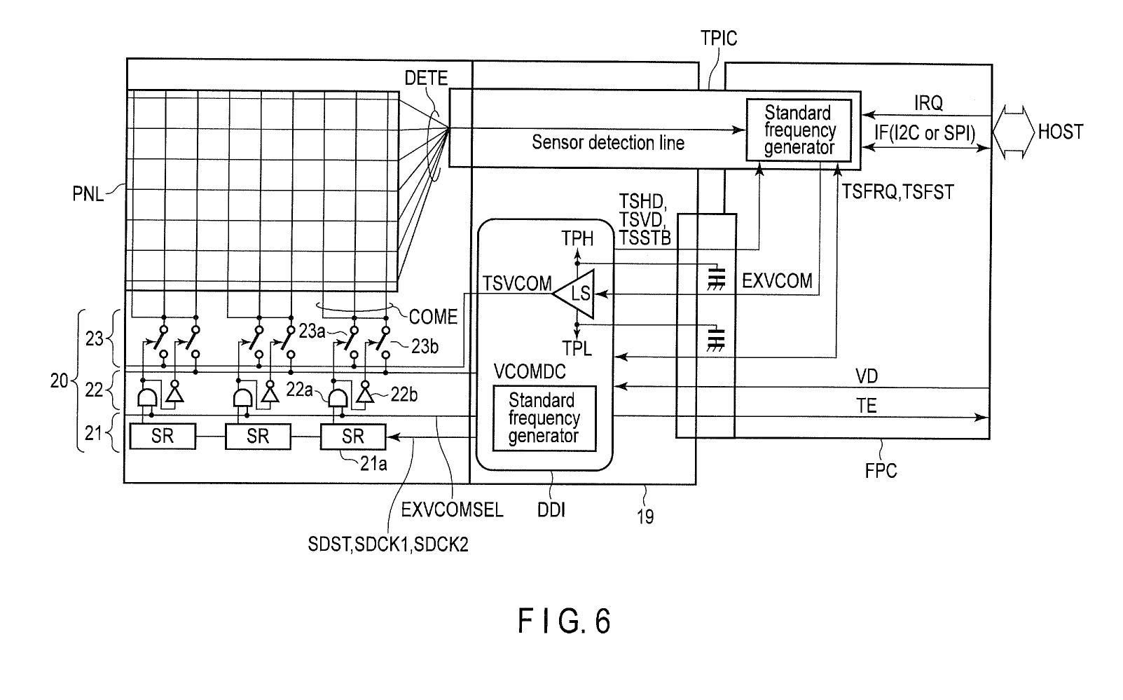

FIG. 6 is an exemplary view for explaining connections of drive source lines in the mutual detection method of the display device DSP having the touch detection function, according to the first embodiment. FIG. 6 shows a two-chip system comprising two IC chips, i.e., the touch driver (TPIC) and the display driver (DDI). In this system, the touch driver TPIC and the display driver DDI performs the touch drive operation and the display operation in cooperation with each other.

In the TFT substrate 19, the display driver DDI is provided. Also, in the TFT substrate 19, a touch drive circuit 20 including shift registers SR is provided. The display driver DDI supplies drive pulses TSVCOM as drive signals output to the common electrode COME through the touch drive circuit 20. In the second substrate SUB2, the detection electrode DETE is provided, and sensor detection lines from the detection electrode DETE are electrically connected to the touch driver TPIC through electrodes for external extension.

The touch driver TPIC is connected to an external processor HOST, with a flexible print circuit (FPC) interposed between them. It should be noted that information is transmitted and received between the touch driver TPIC and the processor HOST by a communication method such as an inter-integrated circuit (I2C) or a serial peripheral interface (SPI).

Next, transmission and reception of signals between the touch driver TPIC and the display driver DDI will be explained.

The display driver DDI outputs a signal for synchronization to the touch driver TPIC. The signal for synchronization includes a vertical synchronizing signal TSVD and a horizontal synchronizing signal TSHD. The vertical synchronizing signal TSVD is a synchronizing signal indicating a start of a frame. The horizontal synchronizing signal TSHD is a synchronizing signal associated with an operation for each of lines in a frame. The touch driver TPIC outputs a drive synchronizing signal EXVCOM, which accurately synchronizes with a sampling timing for touch detection, to the display driver DDI in synchronism with the horizontal synchronizing signal TSHD. The display driver DDI outputs a drive pulse TSVCOM in which the drive synchronizing signal EXVCOM is level-shifted in voltage level and converted in impedance to the touch drive circuit 20.

The touch drive circuit 20 comprises a shift register circuit 21, a selection circuit 22 and a switching circuit 23. A structure and an operation of the touch drive circuit 20 will be explained by referring to by way of example a single shift register 21a and a circuit connected thereto.

To the shift register 21a, a transfer start pulse SDST and transfer clock SDCK 1 are input as transfer-circuit control signals. It is noted that 2 clocks SDCK1 and SDCK2 may be used according to the specification. Shift registers at respective stages are successively supplied with a transfer start pulse SDST using the transfer clock SDCK1 and, and then the transfer start pulse SDST is output from the shift registers. It should be noted that the above shift register uses single transfer clock, i.e., the transfer clocks SDCK 1; however, a shift register adopting a method in which a start pulse is transferred using two transfer clocks SDCK 1 and SDCK 2 may be applied.

An output terminal of the shift register 21a is connected to one of input terminals of an AND circuit 22a included in the selection circuit 22. To the other input terminal of the AND circuit 22a, a drive synchronization selection signal EXVCOMSEL is input. The drive synchronization selection signal EXVCOMSEL is a signal which is set to “1” in the touch position detection period, and set to “0” in the image display period. Thus, in the touch position detection period, and also in a period in which the output of the shift register 21a is “1”, the output of the AND circuit 22a is “1”, and the state of a touch switch 23a provided in the switching circuit 23 is switched to a connected state (on state). On the other hand, in the image display period, the output of the AND circuit 22a is “0”. The output of the AND circuit 22a is set to “1” by an inverter 22b included in the selection circuit 22. The state of a display switch 23b included in the switching circuit 23 is switched to the connected state (on state).

Therefore, in the touch position detection period, and in a period in which the output of the above single shift register 21a is “1”, drive pulses TSVCOM are input to the common electrode COME through the touch switch 23a. On the other hand, in a period in which the output of the above single shift register 21a is “0”, a direct-current signal VCOMDC is input to the common electrodes COME through the touch switch 23a. In the image display period, through the display switch 23b, the direct-current signal VCOMDC is input to the common electrode COME.

It should be noted that one of ends of the touch switch 23a, which is located close to the panel PNL, is connected to at least one of the common electrodes Come arranged in the manner of stripes in the common electrode COME. It is possible to obtain detection signals with a favorable signal to noise ratio by inputting drive pulses TSVCOM, which are supplied as a pulse string, to the above at least one of the common electrodes Come. The number of common electrodes Come arranged in the manner of stripes, which are connected to the above end of the touch switch 23a on the panel PNL side, is not limited to a fixed number, and may be variable. Furthermore, in the touch position detection period, the touch drive operation is performed not only on at least one of the common electrodes Come arranged in the manner of stripes, which is connected to the output of the single shift register, but on common electrodes Come arranged in the manner of stripes, which are connected to outputs of a plurality of shift registers.

It should be noted that in the touch driver TPIC, a standard-frequency generator is provided independently. And in the display driver DDI, a dedicated standard-frequency generator is provided independently. Therefore, a drive frequency for touch drive can be set to an arbitrary value independent of that for display.

Next, transmission and reception of signals between the touch driver TPIC, the display driver DDI and the processor HOST will be explained. Between the touch driver TPIC and the processor HOST, and between the display driver DDI and the processor HOST, information is transmitted and received by a communication method such as the above inter-integrated circuit (I2C) or the serial peripheral interface (SPI), and in addition, an individual signal (e.g., IRQ, VD or TE) is transmitted and received through a terminal of the FPC. Such an individual signal will be explained in detail later.

As explained above, the touch driver TPIC and the display driver DDI perform the touch drive operation and the display operation in cooperation with each other. It should be noted that although in the above explanation, the touch drive operation is referred to, the display driver DDI performs not only the touch drive operation, but also the display operation in accordance with a control signal output from a timing controller (not shown) provided in the display driver DDI. To be more specific, the display driver DDI outputs display signals and a signal for the display operation such that display elements are successively supplied with the display signals and the common electrodes Come included in the common electrode COME are successively supplied with the signal for the display operation.

It should be noted that the display driver DDI, the touch driver TPIC, the touch drive circuit 20, the common electrode COME and the detection electrode DETE as shown in FIG. 6 form a drive device. Furthermore, the drive device and the display panel PNL form the display device having the touch detection function.

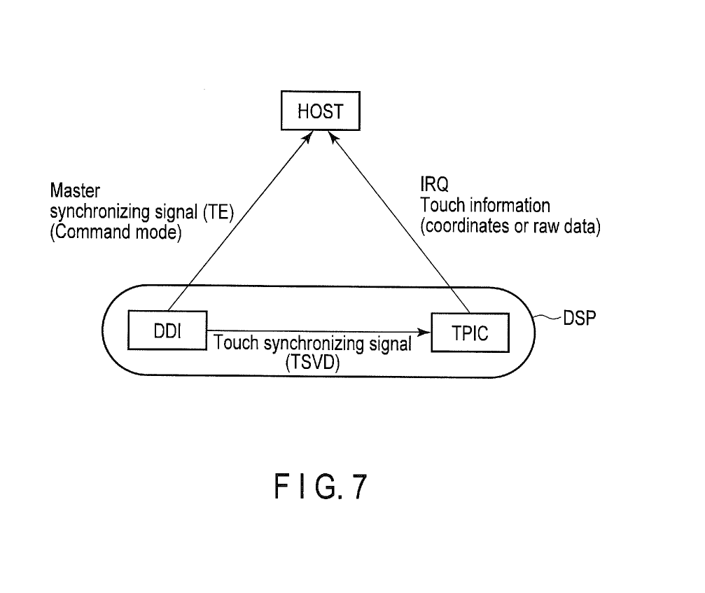

FIG. 7 is an exemplary view showing main signals to be transmitted and received between the processor HOST and the display device DSP having the touch detection function according to the first embodiment. In the first embodiment, the display driver DDI outputs a synchronizing signal as an initiator. It should be noted that the synchronizing signal which the display driver DDI outputs as the initiator is a master synchronizing signal. To be more specific, the display driver DDI outputs a master synchronizing signal (TE) to the processor HOST, and also a touch synchronizing signal (TSVD) to the touch driver TPIC. The touch driver TPIC outputs touch information to the processor HOST. Thereby, those three modules (the display driver DDI, the processor HOST and the touch driver TPIC) achieve operations which synchronize with each other.

It should be noted that the master synchronizing signal (TE) which the display driver DDI outputs to the processor HOST is a signal already used as a tearing effect control signal. A tearing phenomenon occurs when during displaying of image data of a present frame, image data of a subsequent frame is input, i.e., it is a phenomenon in which two or more image data is displayed in a single screen-image. In the first embodiment, the above control signal is also used as the master synchronizing signal TE. However, the master synchronizing signal is not limited to the above control signal, and a signal which generates at an appropriate timing may be newly provided as another master synchronizing signal.

Furthermore, the touch synchronizing signal (TSVD) which the display driver DDI outputs to the touch driver TPIC is the vertical synchronizing signal TSVD which indicates the start of a frame as explained above with reference to FIG. 6. The touch driver TPIC outputs detected raw data or touch coordinates as the touch information to the processor HOST.

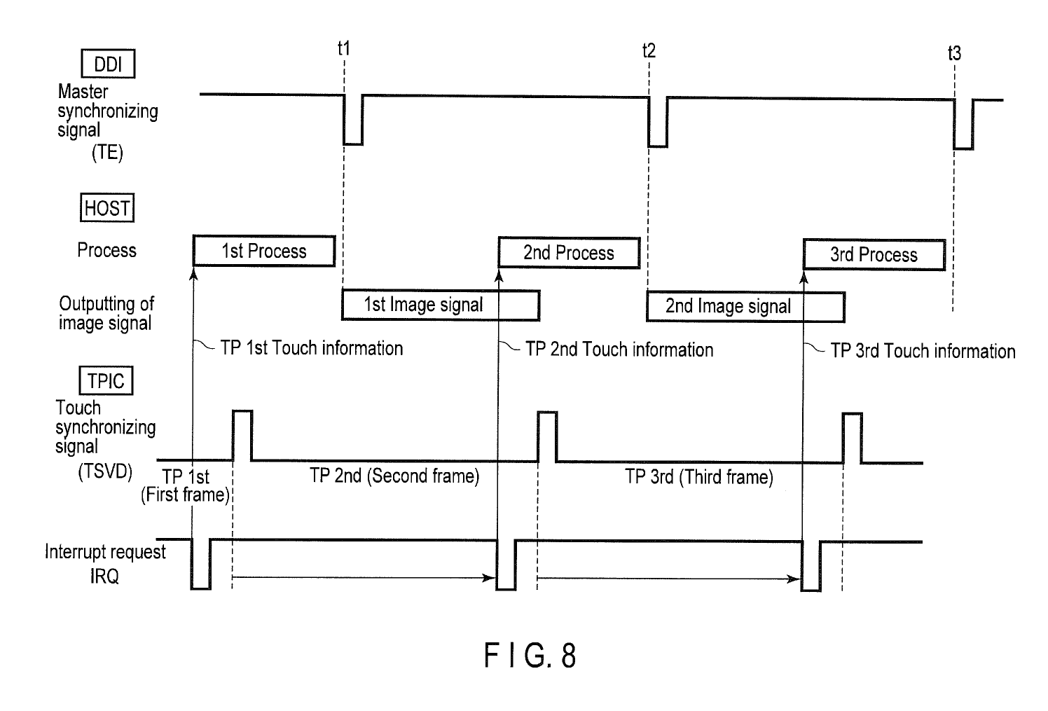

FIG. 8 is an exemplary time chart showing a flow of transmission and reception of main signals between the processor HOST and the display device DSP having the touch detection function according to the first embodiment.

At time t1, the display driver DDI outputs the master synchronizing signal TE to the processor HOST. Upon reception of the master synchronizing signal TE, the processor HOST outputs an image signal of a first frame (1st) on which processing has already been executed to the display driver DDI. Although it is not shown, the display driver DDI outputs display signals obtained by converting the output image signal of the first frame (1st) into pixel voltages to the display elements of the panel PNL.

On the other hand, at time prior to time t1, if receiving the touch synchronizing signal TSVD from the display driver DDI, the touch driver TPIC executes a touch drive associated with a second frame (2nd) to acquire touch information from the detection electrode DETE. Then, if ending acquisition of the touch information with respect to the second frame, the touch driver TPIC outputs an interrupt request (IRQ) to the processor HOST and transmits the touch information.

The processor HOST executes a process (2nd process) associated with the second frame (2nd) in accordance with a touch position acquired from the transmitted touch information. An image signal of the second frame (2nd), which is produced as a result of the above process, is output from the processor HOST to the display driver DDI when the master synchronizing signal TE is input from the display driver DDI at time t2. After predetermined time elapses from reception of the image signal from the processor HOST, the display driver DDI outputs the touch synchronizing signal TSVD to the touch driver TPIC. Thereafter, the above operation is repeatedly performed.

It should be noted that in the processor HOST, an operation of outputting an image signal of the first frame (1st) and an operation of executing the process (2nd process) associated with the second frame are performed in parallel. Furthermore, the timing at which the display driver DDI outputs the master synchronizing signal TE and that at which the touch driver TPIC outputs the interrupt request IRQ are designed in advance so that such a sequence as shown in FIG. 8 can be performed.

It should be noted that a VD (vertical synchronizing signal) to be transmitted from the processor HOST to the display driver DDI as shown in FIG. 6 is a synchronizing signal at the time of outputting an image signal of a single frame. In the first embodiment, the VD is not used in synchronizing operations between the above three modules; however, in the second embodiment, which will be described below, the VD is used in the synchronizing operations between the three modules.

### Second Embodiment

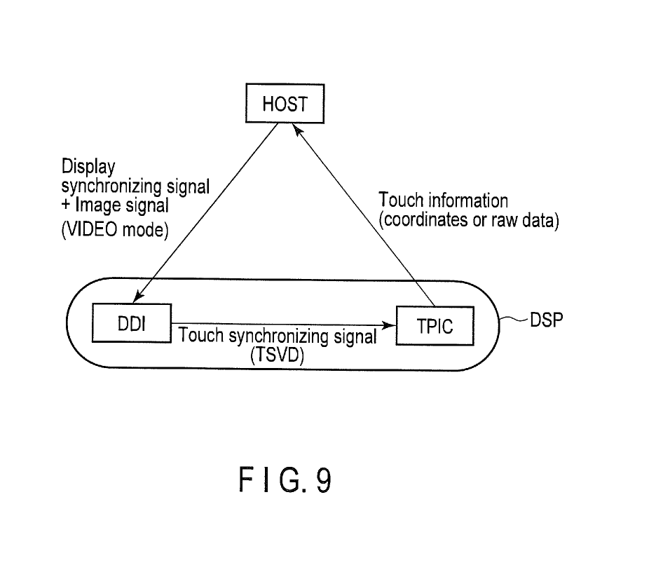

FIG. 9 is an exemplary view showing transmission and reception of main signals between a processor HOST and a display device DSP having a touch detection function, according to the second embodiment. With respect to the second embodiment, elements identical to those in the first embodiment will be denoted by the same reference numerals as in the first embodiment, and their detailed explanation will be omitted.

In the second embodiment, the processor HOST outputs a synchronizing signal as an initiator. To be more specific, the processor HOST outputs the synchronizing signal to the display driver DDI. The synchronizing signal which the processor HOST outputs to the display driver DDI is a VD (vertical) synchronizing signal which is a synchronizing signal at the time of outputting an image signal of a single frame. It should be noted that the synchronizing signal which the processor HOST outputs as an initiator is a display synchronizing signal VD. The display driver DDI outputs a touch synchronizing signal (TSVD) to the touch driver TPIC. The touch driver TPIC outputs touch information to the processor HOST. Thereby, those three modules (the processor HOST, the display driver DDI and the touch driver TPIC) achieve operations which synchronize with each other.

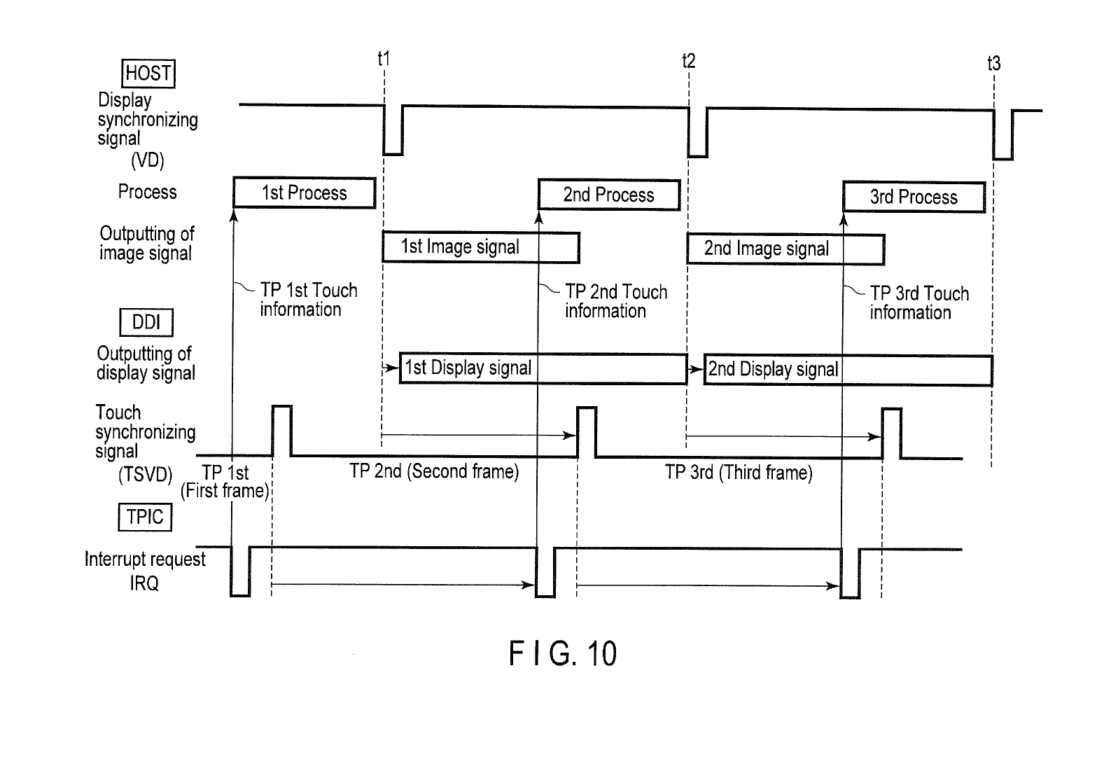

FIG. 10 is an exemplary time chart showing a flow of transmission and reception of main signals between a processor HOST and the display device DSP having the touch detection function according to the second embodiment.

At time T1, the processor HOST outputs a display synchronizing signal VD to the display driver DDI. After outputting the display synchronizing signal VD, the processor HOST outputs an image signal of the first frame (1st) to the display driver DDI. After receiving the display synchronizing signal VD, the display driver DDI outputs display signals obtained by converting the above image signal of the first frame (1st) into pixel voltages to display elements of the panel PNL.

On the other hand, if receiving the touch synchronizing signal TSVD from the display driver DDI at a time prior to the time T1, the touch driver TPIC executes a touch drive (TP 2nd) associated with a second frame, and acquires touch information from the detection electrode DETE. When ending acquisition of touch information associated with the second frame, the touch driver TPIC outputs an interrupt request IRQ to the processor HOST, and transmits the touch information thereto.

The processor HOST executes a process (2nd process) associated with the second frame in accordance with a touch position acquired from the transmitted touch information. At time T2, an image signal of the second frame (2nd) which is produced as a result of the above process is output from the processor HOST to the display driver DDI. Thereafter, the above operation is repeatedly performed.

It should be noted that in the processor HOST, an operation of outputting the image signal of the first frame (1st) to the panel PNL and an operation of executing the process (2nd process) associated with the second frame are performed in parallel. Furthermore, the timing at which the display driver DDI outputs the synchronizing signal TSVD and the timing at which the touch driver TPIC outputs the interrupt request IRQ are designed in advance so that such a sequence as shown in FIG. 10 can be performed.

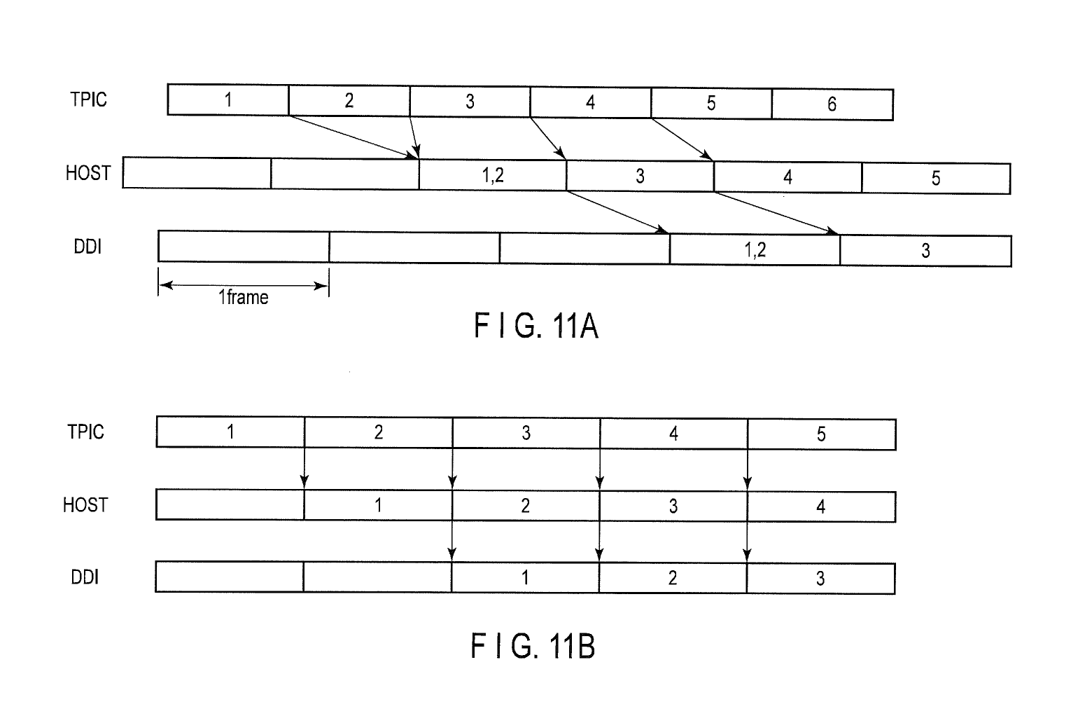

FIGS. 11A and 11B are exemplary views for explaining an advantage of synchronization between the processor HOST and the display device DSP having the touch detection function, according to each of the first and second embodiments. FIG. 11A is a view showing an example of a lag (delay) in asynchronous driving in a conventional drive method. FIG. 11B is a view showing an example of a lag in synchronous driving in the first and second embodiments.

FIG. 11A shows an example of the case where the touch driver TPIC, the processor HOST and the display driver DDI asynchronously operate. It should be noted that the touch driver TPIC, the processor HOST and the display driver DDI operate on a frame basis. The figure shows that frames in which the touch driver TPIC executes processing are divided into frames 1, 2, 3 . . . , and each of timings at which the processor HOST and the display driver DDI execute processing is indicated in unit of frame.

After processing touch information of a single frame, the touch driver TPIC can output it to the processor HOST. However, the processor HOST is configured to accept the touch information at the start of processing to be executed on a frame basis. That is, the processor HOST does not accept the touch information in the middle of the processing to be executed on the frame basis. Thus, even if a small lag occurs, the timing at which the processor HOST executes processing greatly lags. In an example shown in FIG. 11A, in a single frame, the processor HOST processes touch information of two frames, i.e., the first and second frames, which is output from the touch driver TPIC. To be more specific, the processor HOST executes production of an image to be displayed on the panel PNL, based on the touch information of the first and second frames.

Furthermore, in the case where an image obtained by processing by the processor HOST is output as an image signal, the display driver DDI is configured to accept the image signal at the start of processing to be executed on a frame basis. That is, it does not accept the image signal in the middle of the processing to be executed on the frame basis. Thus, even if a small lag occurs, the timing at which the display driver DDI executes processing greatly lags. In the example shown in FIG. 11A, in a 4-th frame, the display driver DDI processes the touch information of the first and second frames, which is output from the touch driver TPIC.

As shown in FIG. 11A, in the asynchronous driving in the conventional driven method, a lag of four frames can occur from time at which an actual touch operation is performed to time at which a reaction thereto is visibly recognized. Also, there is a case where the number of times the touch operation is reflected, varies between frames of the display driver DDI (i.e., frames which are visibly recognizable).

FIG. 11B shows an example of the case where as explained with respect to the first and second embodiments, the touch driver TPIC, the processor HOST and the display driver DDI operate in synchronism with each other. Touch information from the touch driver TPIC is reflected in a subsequent frame for the processor HOST, and in a further subsequent frame for the display driver DDI. Therefore, a lag of three frames occurs from time at which an actual touch operation is performed to time at which a reaction thereto is visibly recognized. However, touch information can be precisely reflected in a frame as compared with the conventional drive method.

It should be noted that the present invention is not limited to such a panel structure as described with respect to each of the embodiments.

With respect to the embodiments, a panel using a liquid crystal which is of a lateral electric-field type such as an in-plane switching (IPS) mode or a fringe-field switching (FFS) mode is referred to by way of example; however, the panel applied to each of the embodiments is not limited to such a type of panel. That is, the embodiments can also be applied to a panel using a liquid crystal which is of a vertical electric-field type such as a twisted nematic (TN) mode or an optically compensated bend (OCB) mode.

Furthermore, with respect to the embodiments, as the display device having the touch detection function, a so-called in-cell type display device is referred to by way of example. However, the embodiment can also be applied to a so-called on-cell type display device in which a touch panel is provided on a display surface of the display device.

It should be noted that the present invention can be expressed as follows:
(1) An aspect of the invention disclosed relates to a drive device which comprises:
a plurality of drive electrodes arranged side by side to extend in a first direction;
a plurality of detection electrodes extending in a second direction crossing the first direction, and provided to generate capacitances at intersections of the detection electrodes and the drive electrodes;
a display driver which performs
   a touch scanning drive in which the drive electrodes are successively supplied with a touch drive signal for detecting a closely situated external object, and
   a display scanning drive in which display elements are successively supplied with display signals to be displayed by the display elements, after producing the display signals from an image signal input from the outside; and
a touch driver which obtains touch information including detection information on the closely situated external object by acquiring detection signals from the detection electrodes,
wherein
the display driver acquires the image signal, which is input in response to a master synchronizing signal (TE) output to the outside, and outputs the touch synchronizing signal (TSVD) to the touch driver after a predetermined time elapses from time when the image signal is input, and
the touch driver starts to operate in response to
the touch synchronizing signal (TSVD) from the display driver, to acquire the touch information, and outputs the touch information to the outside to cause production of the image signal to start.
(2) Another aspect of the invention disclosed relates to a drive device which comprises:
a plurality of drive electrodes arranged side by side to extend in a first direction;
a plurality of detection electrodes extending in a second direction crossing the first direction, and provided to generate capacitances at intersections of the detection electrodes and the drive electrodes;
a display driver which performs
   a touch scanning drive in which the drive electrodes are successively supplied with a touch drive signal for detecting a closely situated external object, and
   a display scanning drive in which display elements are successively supplied with display signals to be displayed by the display elements, after producing the display signals from an image signal input from the outside; and
a touch driver which obtains touch information including detection information on the closely situated external object by acquiring detection signals from the detection electrodes,
wherein
the display driver produces display signals from the image signal upon reception of a display synchronizing signal (VD) input from the outside to the display driver, and then outputs the display signals to display elements; and outputs a touch synchronizing signal (TSVD) to the touch driver after a predetermine time elapses from time at which the display synchronizing signal (VD) is input, and
the touch driver starts to operate in response to the touch synchronizing signal (TSVD) from the display driver, to acquire the touch information, and outputs the touch information to the outside to cause production of the image signal to start.
(3) Still another aspect of the invention disclosed relates to the drive device according to item (1) or (2),
wherein
the display device performs a touch scanning drive by supplying a touch drive signal (TSVCOM) having pulses for detecting the closely situated external object, and
the touch driver receives a signal including the touch synchronizing signal (TSVD), outputs a drive synchronizing signal (EXVCOM) for producing the touch drive signal (TSVCOM) to the display driver, and acquires detection signals from the detection electrodes at timing corresponding to input of the pulses of the touch drive signal (TSVCOM) to detect the closely situated external object.
(4) A further aspect of the invention disclosed relates to a display device having a touch detection function comprising: the drive device according to any of items (1)-(3), and display pixels for displaying based on the display signals, wherein the display driver repeatedly alternately performs the display scanning drive and the touch scanning drive in a time sharing manner, and in the display scanning drive, the display diver supplies the display signals to the display pixels, respectively.
(5) A still further aspect of the invention disclosed relates to an information processing device comprising: the drive device according to item (1), and a processor which processes information, wherein the processor produces the image signal based on the touch information input from the touch driver, and outputs the produced image signal to the display driver in accordance with the master synchronizing signal (TE) input from the display driver.
(6) An additional aspect of the invention disclosed relates an information processing device comprising: the drive device according to item (2), and a processor which processes information, wherein the processor produces the image signal based on the touch information input from the touch driver, and then outputs the produced image signal and the display synchronizing signal (VD) to the display driver.

All display devices which can be put to practical use by a person with ordinary skill in the art by changing as appropriate the designs of the display devices according to the above embodiments are covered by the disclosure of the present application, as long as they have the subject matter of the present invention.

It can be understood that within the scope of the technical concept of the present invention, various modifications of the embodiments of the present invention can be conceived by a person with ordinary skill in the art, and also fall within the scope of disclosure of the present application with respect to the present invention. For example, with respect to the above embodiments, if a person with ordinary skill in the art adds or deletes a structural element or changes a design as appropriate, or adds or omits a step or changes a design, a modification obtained by such a change also falls within the scope of disclosure of the present application with respect to the present invention, as long as it has the subject matter of the present invention.

Furthermore, in addition to the above advantages obtained by the above embodiments, if another or other advantages can be obviously considered to be obtained in the embodiment or embodiments from the specification or can be conceived as appropriate by a person with ordinary sill in the art from the specification, it is understood that such another or other advantages can also be obtained by the present invention.

It is also possible to make various inventions by combining as appropriate, structural elements as disclosed with respect to the above embodiments. For example, some of the structural elements in the embodiments may be deleted. Also, structural elements used in both the embodiments may be combined as appropriate.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A display device having touch detection function, comprising:
a plurality of drive electrodes arranged side by side to extend in a first direction;
a plurality of detection electrodes extending in a second direction crossing the first direction, and provided to generate capacitances at intersections of the detection electrodes and the drive electrodes;
a display driver which performs
a touch scanning drive in which the drive electrodes are successively supplied with a touch drive signal for detecting a closely situated external object, and
a display scanning drive in which display elements are successively supplied with display signals to be displayed by the display elements, after producing the display signals from an image signal input from the outside; and
a touch driver which obtains touch information including detection information on the closely situated external object by acquiring detection signals from the detection electrodes,
wherein
the display driver acquires the image signal, which is input in response to a master synchronizing signal output to the outside, and outputs the touch synchronizing signal to the touch driver after a predetermined time elapses from time when the image signal is input, and
the touch driver starts to operate in response to
the touch synchronizing signal from the display driver, to acquire the touch information, and outputs the touch information to the outside to cause production of the image signal to start.

2. The display device having touch detection function, according to claim 1,
wherein
the display device performs a touch scanning drive by supplying a touch drive signal having pulses for detecting the closely situated external object, and
the touch driver receives a signal including the touch synchronizing signal, outputs a drive synchronizing signal for producing the touch drive signal to the display driver, and acquires detection signals from the detection electrodes at timing corresponding to input of the pulses of the touch drive signal to detect the closely situated external object.

3. The display device having touch detection function, according to claim 1, further comprising display pixels for displaying based on the display signals,
wherein the display driver repeatedly alternately performs the display scanning drive and the touch scanning drive in a time sharing manner, and in the display scanning drive, the display diver supplies the display signals to the display pixels, respectively.

4. The display device having touch detection function, according to claim 1, further comprising a processor which processes information,
wherein the processor produces the image signal based on the touch information input from the touch driver, and outputs the produced image signal to the display driver in accordance with the master synchronizing signal input from the display driver.

5. A display device having touch detection function, comprising:
a plurality of drive electrodes arranged side by side to extend in a first direction;
a plurality of detection electrodes extending in a second direction crossing the first direction, and provided to generate capacitances at intersections of the detection electrodes and the drive electrodes;
a display driver which performs
a touch scanning drive in which the drive electrodes are successively supplied with a touch drive signal for detecting a closely situated external object, and
a display scanning drive in which display elements are successively supplied with display signals to be displayed by the display elements, after producing the display signals from an image signal input from the outside; and
a touch driver which obtains touch information including detection information on the closely situated external object by acquiring detection signals from the detection electrodes,
wherein
the display driver produces display signals from the image signal upon reception of a display synchronizing signal input from the outside to the display driver, and then outputs the display signals to display elements; and outputs a touch synchronizing signal to the touch driver after a predetermine time elapses from time at which the display synchronizing signal is input, and
the touch driver starts to operate in response to the touch synchronizing signal from the display driver, to acquire the touch information, and outputs the touch information to the outside to cause production of the image signal to start.

6. The display device having touch detection function, according to claim 5,
wherein
the display device performs a touch scanning drive by supplying a touch drive signal having pulses for detecting the closely situated external object, and
the touch driver receives a signal including the touch synchronizing signal, outputs a drive synchronizing signal for producing the touch drive signal to the display driver, and acquires detection signals from the detection electrodes at timing corresponding to input of the pulses of the touch drive signal to detect the closely situated external object.

7. The display device having touch detection function, according to claim 5, further comprising display pixels for displaying based on the display signals,
wherein the display driver repeatedly alternately performs the display scanning drive and the touch scanning drive in a time sharing manner, and in the display scanning drive, the display diver supplies the display signals to the display pixels, respectively.

8. The display device having touch detection function, according to claim 5, further comprising a processor which processes information,
wherein the processor produces the image signal based on the touch information input from the touch driver, and then outputs the produced image signal and the display synchronizing signal to the display driver.
